(19) United States
(12) Patent Application Publication
(10) Pub. No.: US 2009/0154736 A1
(43) Pub. Date: Jun. 18, 2009

(54) APPARATUS FOR GENERATING DIRECTIONAL SOUND AND MOBILE TERMINAL USING THE SAME

(75) Inventors: Sung Q Lee, Daejeon (KR); Jae Woo Lee, Daejeon (KR); Hye Jin Kim, Daejeon (KR); Sang Kyun Lee, Gwangju (KR); Kang Ho Park, Daejeon (KR); Jong Dae Kim, Daejeon (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon (KR)

(21) Appl. No.: 12/240,128

(22) Filed: Sep. 29, 2008

(30) Foreign Application Priority Data
Dec. 17, 2007 (KR) 2007-132735

(51) Int. Cl. H04R 5/02

(52) U.S. Cl. 381/300

(57) ABSTRACT

Provided are an apparatus for generating directional sound and a mobile terminal using the apparatus. The apparatus includes a signal controller for dividing and generating a reference signal into signals having three or more levels and phases, a first signal processor and a second signal processor for controlling a first signal and a second signal having levels and phases canceling each other among the signals generated from the signal controller, a central signal processor for controlling a signal having the same level and phase as the reference signal among the signals generated from the signal controller, a first speaker array and a second speaker array for converting signals output from the first signal processor and the second signal processor into sound signals and outputting the sound signals, and a central speaker for converting a signal output from the central signal processor into a sound signal and outputting the sound signal, and arranged between the first speaker array and the second speaker array.

### CROSS-REFERENCE TO RELATED APPLICATION

This application claims priority to and the benefit of Korean Patent Application No. 2007-132735, filed Dec. 17, 2007, the disclosure of which is incorporated herein by reference in its entirety.

### BACKGROUND

1. Field of the Invention

The present invention relates to an apparatus for generating directional sound and a mobile terminal using the apparatus, and more particularly, to an apparatus for generating directional sound using not a high frequency but an audio frequency and a mobile terminal using the apparatus.

This work was supported by the IT R&D program of MIC/IITA [2006-S-006-02, Components/Module technology for Ubiquitous Terminals].

2. Discussion of Related Art

As a society becomes complex, personal activities are drawing more attention than mutual activities, and personal space is becoming more important. As for sound, a sound or voice effect that only one person can hear is needed, and a desire not to invade others' personal space and not to be bothered by others are increasing. In this situation, use of earphones is inconvenient and overstrains one's ears. Thus, the necessity to directly hear music or a broadcast through speakers is increasing. One important capability that a speaker must have in order to meet the necessity is directivity.

Directivity denotes a characteristic in which a frequency characteristic of sound pressure varies according to a radiation direction of a speaker. Directivity must be considered when designing a system transferring sound in a direction in a public place or a place requiring silence. For example, a sound system for describing the corresponding picture in an art exhibition requires narrow directivity, which denotes that sound of a speaker is propagated in a specific direction. However, audio systems may be required to have wide directivity, and thus a directivity pattern must be determined according to the purpose of a speaker and a size of an area to which a loudspeaker will emit sound. Such a directivity pattern is implemented by a single speaker or respectively controlling and summing phases and levels in a line source speaker system in which several speakers are arranged in a straight line. Therefore, the directivity of a speaker system is determined according to a physical structure or arrangement of the corresponding speaker unit.

FIG. 1 is a block diagram of a conventional apparatus for generating directional sound. Referring to FIG. 1, the conventional apparatus for generating directional sound comprises a speaker array 105 consisting of a plurality of speakers, an amplification unit 103 for amplifying a signal transferred to the speaker array 105, a Digital Audio Signal Processor (DASP) unit 101 for controlling a signal input from a first input terminal 111 and a second input terminal 113 according to a digital filter coefficient, and a control unit 107 for controlling operation of the DASP unit 101.

The conventional apparatus for generating directional sound includes a line of speakers arranged as indicated by a reference numeral 120. A sound signal output from the speakers can be emitted in a direction 121 or 123.

However, even when the conventional apparatus for generating directive sound outputs sound, for example, in the direction 121, a lobe of the sound pressure is not sharp. Therefore, the sound is heard nearby as well as in the direction.

### SUMMARY OF THE INVENTION

The present invention is directed to an apparatus for generating directional sound and a mobile terminal using the apparatus.

The present invention is also directed to an apparatus for generating directional sound effective even for low-frequency signals and a mobile terminal using the apparatus.

One aspect of the present invention provides an apparatus for generating directional sound, comprising: a signal controller for dividing and generating a reference signal into signals having three or more levels and phases; a first signal processor and a second signal processor for controlling a first signal and a second signal having levels and phases canceling each other among the signals generated from the signal controller; a central signal processor for controlling a signal having the same level and phase as the reference signal among the signals generated from the signal controller; a first speaker array and a second speaker array for converting signals output from the first signal processor and the second signal processor into sound signals, and outputting the sound signals; and a central speaker for converting a signal output from the central signal processor into a sound signal and outputting the sound signal, and arranged between the first speaker array and the second speaker array.

The first speaker array and the second speaker array may be arranged along a left side and a right side of the central speaker at the same interval. The apparatus for generating directional sound may further comprise a first switch and a second switch for intercepting signals transferred to the first signal processor and the second signal processor among the signals generated from the signal controller. The apparatus for generating directional sound may further comprise a first amplifier, a second amplifier and a central amplifier for amplifying the signals output from the first signal processor, the second signal processor and the central signal processor. The first signal processor, the second signal processor and the central signal processor may include an Analog-to-Digital Converter (ADC), a Digital Signal Processor (DSP), a Digital-to-Analog Converter (DAC) and a low-power amplifier. The DSP may process a digital signal using a unique phase and a filter coefficient corresponding to a signal input to each signal processor. The signal controller generates the first and second signals having levels and phases determined to reinforce each other in a region in front of the central speaker, and to cancel each other in a region outside a previously set angle from the region in front of the central speaker. The sound signals output from the first speaker array, the second speaker array and the central speaker may be within an audio frequency band. The first speaker array, the second speaker array and the central speaker may include a piezoelectric speaker.

Another aspect of the present invention provides a mobile terminal, comprising: a speaker unit for generating a sound signal; a first speaker array having a plurality of speakers arranged in a left side of the speaker unit; and a second speaker array having a plurality of speakers arranged in a right side of the speaker unit. Here, sound signals output from the first speaker array and the second speaker array cancel each other out of a specific range.

The first speaker array and the second speaker array may be detachable from the mobile terminal. The first speaker array and the second speaker array may include hinges at portions adjacent to the speaker unit, and may be folded at the hinges to be inserted into left and right sides of the mobile terminal.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram of a conventional apparatus for generating directional sound;

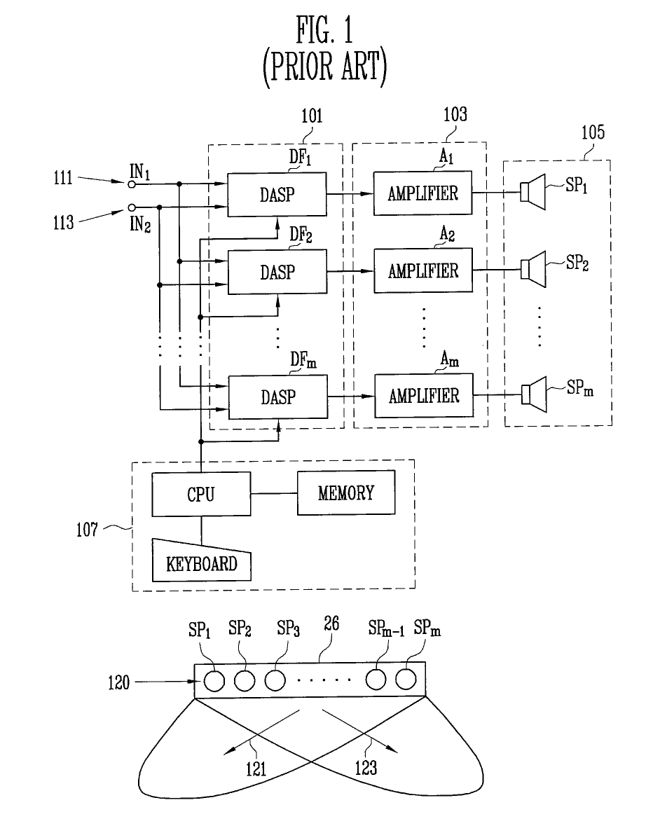

FIG. 2 is a conceptual diagram illustrating a principle of the present invention;

FIG. 3 is a block diagram of an apparatus for generating directional sound according to an exemplary embodiment of the present invention;

FIG. 4 illustrates lobes of sound generated from an apparatus for generating directional sound according to an exemplary embodiment of the present invention;

FIG. 5 illustrates a portable apparatus for generating directional sound according to an exemplary embodiment of the present invention; and

FIG. 6 illustrates a portable apparatus for generating directional sound according to another exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

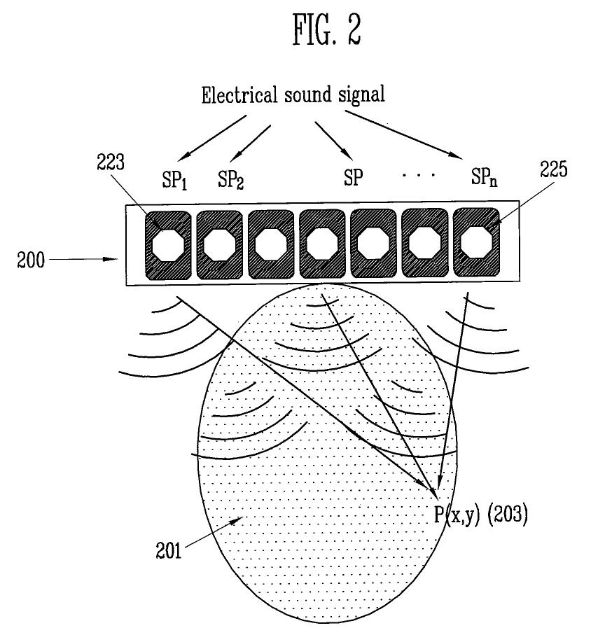

FIG. 2 is a conceptual diagram illustrating a principle of the present invention.

An apparatus for generating directional sound according to an exemplary embodiment of the present invention is implemented using a speaker array 200 including a plurality of speakers connected in one line.

The respective speakers may output sound signals having different sound pressures and phases. In particular, when speakers 223 and 225 output sound signals having the same sound pressure and opposite phases, a listener in a specific region where the signals cancel each other cannot hear the sound, and a listener in a specific region where the signals reinforce each other hears the reinforced sound.

According to such destructive and constructive interference effects of sound waves, constructive interference may occur between signals output from the speaker array 200 to increase the sum of sound waves at a spot 203 in a previously determined personal sound space 201, and destructive interference may occur between the output signals to decrease the sum of sound waves outside the personal sound space 201. In this case, while it is possible to normally hear sound in the personal sound space 201, it is difficult to hear the sound outside the personal sound space 201.

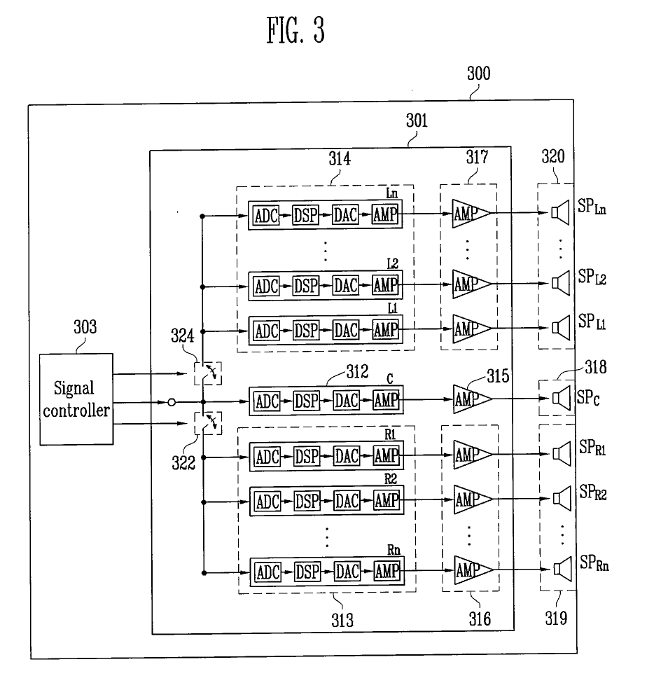

FIG. 3 is a block diagram of an apparatus for generating directional sound according to an exemplary embodiment of the present invention.

Referring to FIG. 3, the apparatus for generating directional sound includes a signal controller 303, a first switch 324, a second switch 322, a first signal processor 314, a central signal processor 312, a second signal processor 313, a first amplification unit 317, a central amplifier 315, a second amplification unit 316, a first speaker array 320, a central speaker 318 and a second speaker array 319.

The signal controller 303 functions to modify the phase and the level of a signal input from outside to correspond to the respective signal processors 314, 312 and 313 and transfer the modified signals.

The first and second switches 324 and 322 function to intercept or transfer a signal 323 transferred to the first signal processor 314 and a signal 321 transferred to the second signal processor 313 among the signals output from the signal controller 303. The first and second switches 324 and 322 allow the apparatus to perform the same operation as a general speaker when it is unnecessary to generate directional sound according to the present invention.

The first signal processor 314 and the second signal processor 313 perform analog-to-digital conversion, digital signal processing, digital-to-analog conversion and low-power amplification on signals received from the signal controller 303. Here, the respective signals input to the respective signal processors have phases and levels controlled by the signal controller 303, and Digital Signal Processors (DSPs) existing in the respective signal processors process the input signals having unique phases using unique filter coefficients.

The central signal processor 312 performs analog-to-digital conversion, digital signal processing, digital-to-analog conversion and low-power amplification on a signal having a phase not changed from a phase of the input signal among signals received from the signal controller 303. In other words, a sound wave processed and output from the central signal processor 312 may have similar phase and level to a signal output from a general speaker system.

The first amplification unit 317, the central amplifier 315 and the second amplification unit 316 function to amplify signals processed by the signal processors 314, 312 and 313.

The first speaker array 320 and the second speaker array 319 function to convert signals processed by the first and second signal processors 314 and 313 into sound signals. The first and second speaker arrays 320 and 319 are equally arranged in one line along the left and right sides of the central speaker 318. Due to the arrangement, destructive interference and constructive interference occur between sound waves generated from the first and second speaker arrays 320 and 319. Thus, sound may be generated only in front of the central speaker 318, and sound level may be remarkably reduced in the other area.

The central speaker 318 functions to convert a signal output from the central signal processor 312 into a sound signal.

The apparatus for generating directional sound constituted as described above modifies a sound signal to generate sound signals having several phases and levels, and thereby can generate directional sound audible only in front of the apparatus.

Unlike conventional art, the directional sound generated in this way has excellent directivity. In addition, using a restriction method of steeply reducing the level of low-frequency sound according to distance, low-frequency sound that is difficult to process using a conventional method can be heard only in a specific region. However, when the restriction method is used for low-frequency sound, directivity is not controlled.

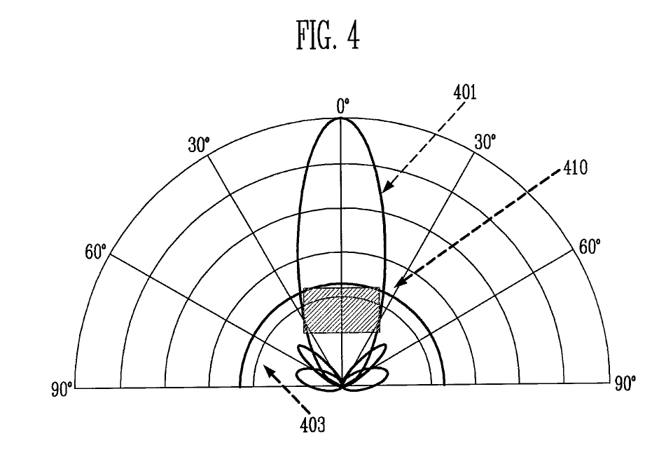

FIG. 4 illustrates lobes of sound generated from an apparatus for generating directional sound according to an exemplary embodiment of the present invention.

Referring to FIG. 4, a lobe 401 denotes directivity of a high-frequency sound signal. As can be seen from FIG. 4, the apparatus for generating directional sound according to an exemplary embodiment of the present invention has high directivity with only few side lobes generated in flank.

A lobe 403 denotes directivity of a low-frequency sound signal. As can be seen from FIG. 4, a low-frequency sound signal does not have directivity in a specific direction, but is not propagated over a specific range because the sound pressure of the low-frequency steeply decreases according to distance.

Therefore, it is possible to form a personal sound space for a listener existing in a section 410.

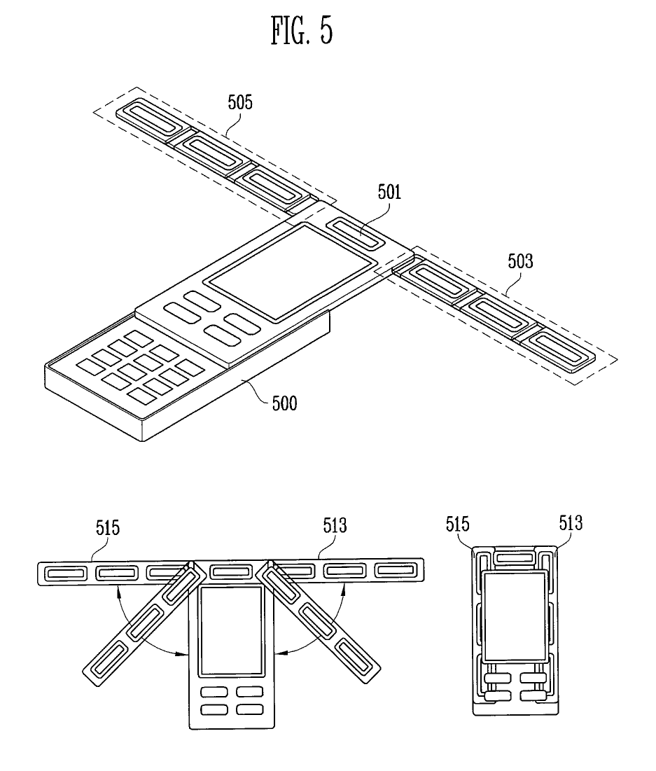

FIG. 5 illustrates a portable apparatus for generating directional sound according to an exemplary embodiment of the present invention.

Referring to FIG. 5, an apparatus for generating directional sound according to an exemplary embodiment of the present invention is applied to a mobile terminal 500. In a general mobile terminal, a speaker outputting sound received from a transmitting terminal is installed as a speaker unit 501 of the mobile terminal 500. Since conventional speakers do not have directivity, sound may be heard by others when a user talks over the terminal in a public place.

However, when the apparatus for generating directional sound according to an exemplary embodiment of the present invention is applied to a mobile terminal, the speaker unit 501 serves as the central speaker described with reference to FIG. 3, and a first speaker array 505 and a second speaker array 503 arranged in one line along the left and right sides of the speaker unit 501 serve as the first and second speaker arrays of FIG. 3. In this case, sound output from the speaker unit 501 is not heard outside, and thus it is possible to maintain confidentiality and privacy of a phone call in a public place, and so on.

The mobile terminal 500 has hinges at portions where the first and second speaker arrays 505 and 503 are coupled to the mobile terminal 500 itself and has slots therein. Thus, when the first and second speaker arrays 505 and 503 are not used, the first and second speaker arrays 505 and 503 can be folded into the left and right sides of the mobile terminal 500 as indicated by reference numerals 513 and 515.

Using the above structure, it is possible to propose a mobile terminal including an apparatus for generating directional sound that can be conveniently carried and maintain privacy.

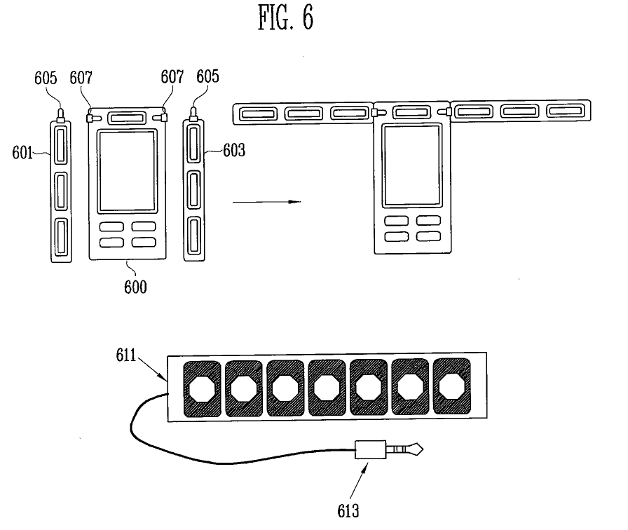

FIG. 6 illustrates a portable apparatus for generating directional sound according to another exemplary embodiment of the present invention.

Referring to FIG. 6, a detachable apparatus for generating directional sound is applied to a mobile terminal 600 according to another exemplary embodiment of the present invention.

A central unit of the apparatus for generating directional sound according to another exemplary embodiment of the present invention can similarly serve as a conventional speaker, and thus a speaker of a conventional mobile terminal is used as a central speaker. Prominence and depression parts or screw hole parts for coupling 607 are formed on the left and right sides of the central speaker, and then prominence and depression parts or screw parts 605 that can be combined with the coupling parts 607 formed on sides of the mobile terminal 600 are added to a first speaker unit 603 and a second speaker unit 601 detachable from the mobile terminal 600. Therefore, the first and second speaker units 603 and 601 may be added to the mobile terminal 600 when directional sound is needed, and detached from the mobile terminal 600 when directional sound is not needed.

As still another exemplary embodiment, a separately manufactured apparatus 611 for generating directional sound having an earphone terminal 613 that can be combined with a general earphone terminal of a mobile terminal may be carried.

To implement such a portable apparatus for generating directional sound, speakers constituting the apparatus must be small and have excellent performance. As the speakers, piezoelectric speakers manufactured through a Microelectromechanical Systems (MEMS) process may be used.

The present invention can provide an apparatus for generating directional sound and a mobile terminal using the apparatus.

In addition, the present invention can provide an apparatus for generating directional sound effective even for low-frequency signals and a mobile terminal using the apparatus

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for generating directional sound, comprising:
a signal controller for dividing and generating a reference signal into signals having three or more levels and phases;
a first signal processor and a second signal processor for controlling a first signal and a second signal having levels and phases canceling each other among the signals generated from the signal controller;
a central signal processor for controlling a signal having the same level and phase as the reference signal among the signals generated from the signal controller;
a first speaker array and a second speaker array for converting signals output from the first signal processor and the second signal processor into sound signals, and outputting the sound signals; and
a central speaker for converting a signal output from the central signal processor into a sound signal and outputting the sound signal, and arranged between the first speaker array and the second speaker array.

2. The apparatus of claim 1, wherein the first speaker array and the second speaker array are arranged along a left side and a right side of the central speaker at the same interval.

3. The apparatus of claim 1, further comprising:
a first switch and a second switch for cutting signals transferred to the first signal processor and the second signal processor among the signals generated from the signal controller.

4. The apparatus of claim 1, further comprising:
a first amplifier, a second amplifier and a central amplifier for amplifying the signals output from the first signal processor, the second signal processor and the central signal processor.

5. The apparatus of claim 1, wherein the first signal processor, the second signal processor and the central signal processor comprise:
an Analog-to-Digital Converter (ADC);
a Digital Signal Processor (DSP);
a Digital-to-Analog Converter (DAC); and
a low-power amplifier.

6. The apparatus of claim 5, wherein the DSP processes a digital signal using a unique phase and a filter coefficient corresponding to a signal input to each signal processor.

7. The apparatus of claim 1, wherein the signal controller generates the first and second signals having levels and phases determined to reinforce each other in a region in front of the central speaker, and to cancel each other in a region outside a previously set angle from the region in front of the central speaker.

8. The apparatus of claim 1, wherein the sound signals output from the first speaker array, the second speaker array and the central speaker are within an audio frequency band.

9. The apparatus of claim 1, wherein the first speaker array, the second speaker array and the central speaker include a piezoelectric speaker.

10. A mobile terminal, comprising:
a speaker unit for generating a sound signal;
a first speaker array having a plurality of speakers arranged in a left side of the speaker unit; and
a second speaker array having a plurality of speakers arranged in a right side of the speaker unit,
wherein sound signals output from the first speaker array and the second speaker array cancel each other out of a specific range.

11. The mobile terminal of claim 10, wherein the first speaker array and the second speaker array are detachable from the mobile terminal.

12. The mobile terminal of claim 10, wherein the first and second speaker arrays include hinges at portions adjacent to the speaker unit, and are folded at the hinges to be inserted into left and right sides of the mobile terminal.
